(19) United States
(12) Patent Application Publication
(10) Pub. No.: US 2006/0072260 A1
(43) Pub. Date: Apr. 6, 2006

(54) Electrostatic protection circuit

(76) Inventors: Masahito Arakawa, Kawasaki (JP); Sadayoshi Umeda, Kawasaki (JP)

Correspondence Address: ARENT FOX PLLC, 1050 CONNECTICUT AVENUE, N.W., SUITE 400, WASHINGTON, DC, 20036, US

(21) Appl. No.: 11/024,491

(22) Filed: Dec. 30, 2004

(30) Foreign Application Priority Data
Sep. 28, 2004 (JP) 2004-282033

(51) Int. Cl. H02H 9/00

(52) U.S. Cl. 361/56

(57) ABSTRACT

An electrostatic protection circuit having an external power supply terminal, an external ground terminal, a first external signal terminal, a first p-type field-effect transistor having a source and a drain respectively connected to the external power supply terminal and the first external signal terminal, a first n-type field-effect transistor having a source and a drain respectively connected to the external ground terminal and the first external signal terminal, and an electrostatic detection circuit is provided. The electrostatic detection circuit turns off the first p-type field-effect transistor and the first n-type field-effect transistor when it does not detect static electricity, and the electrostatic detection circuit turns on the first p-type field-effect transistor and the first n-type field-effect transistor when it detects static electricity.

### CROSS-REFERENCE TO RELATED APPLICATIONS

This application is based upon and claims the benefit of priority from the prior Japanese Patent Application No. 2004-282033, filed on Sep. 28, 2004, the entire contents of which are incorporated herein by reference.

### BACKGROUND OF THE INVENTION

1. Field of the Invention

The present invention relates to an electrostatic protection circuit, and particularly to an electrostatic protection circuit connected to an external power supply terminal, an external ground terminal and an external signal terminal.

2. Description of the Related Art

An electrostatic protection circuit is a semiconductor input/output circuit, and is a circuit for preventing breakdown of an internal circuit due to static electricity. An ESD (Electrostatic Discharge) protection circuit is described in ESD in Silicon Integrated Circuits Second Edition, Ajith Amerasekera, Charvaka Duvvury et. al., P112 to P116, JOHN WILEY & SONS, LTD, 2002. FIG. 1 of U.S. Pat. No. 5,355,344 and U.S. Pat. No. 5,526,317 (Japanese Patent Application Laid-open No. 6-216328) shows an address signal input ESD structure in which a gate of an n-type MOS field-effect transistor M1 is connected to power supply voltage via one inverter 18, and a gate of a p-type MOS field-effect transistor M2 is connected to the power supply voltage via two inverters 18.

### SUMMARY OF THE INVENTION

An object of the present invention is to provide an electrostatic protection circuit which reliably operates at high speed.

According to one aspect of the present invention, an electrostatic protection circuit having an external power supply terminal, an external ground terminal, a first external signal terminal, a first p-type field-effect transistor having a source and a drain respectively connected to the external power supply terminal and the first external signal terminal, a first n-type field-effect transistor having a source and a drain respectively connected to the external ground terminal and the first external signal terminal, and an electrostatic detection circuit is provided. The electrostatic detection circuit is connected to the external power supply terminal and the external ground terminal, and turns off the first p-type field-effect transistor and the first n-type field-effect transistor when it does not detect static electricity and turns on the first p-type field-effect transistor and the first n-type field-effect transistor when it detects static electricity.

### BRIEF DESCRIPTION OF THE DRAWINGS

FIG. 1 is a circuit diagram showing a constitution example of an electrostatic protection circuit according to a first embodiment of the present invention;

FIG. 2 is a circuit diagram showing a constitution example of an electrostatic detection circuit according to a second embodiment of the present invention;

FIG. 3 is a circuit diagram showing a constitution example of an electrostatic detection circuit according to a third embodiment of the present invention;

FIG. 4 is a circuit diagram showing a constitution example of an electrostatic detection circuit according to a fourth embodiment of the present invention;

FIG. 5 is a circuit diagram showing a constitution example of an electrostatic detection circuit according to a fifth embodiment of the present invention;

FIG. 6 is a circuit diagram showing a constitution example of an electrostatic detection circuit according to a sixth embodiment of the present invention;

FIG. 7 is a circuit diagram showing a constitution example of an electrostatic detection circuit according to a seventh embodiment of the present invention;

FIG. 8 is a circuit diagram showing a constitution example of an electrostatic detection circuit according to an eighth embodiment of the present invention;

FIG. 9 is a circuit diagram showing a constitution example of an electrostatic protection circuit according to a ninth embodiment of the present invention;

FIG. 10 is a circuit diagram showing a constitution example of an electrostatic protection circuit according to a tenth embodiment of the present invention;

FIG. 11 is a circuit diagram showing a constitution example of an electrostatic detection circuit according to an eleventh embodiment of the present invention;

FIG. 12 is a circuit diagram showing a constitution example of an electrostatic detection circuit according to a twelfth embodiment of the present invention;

FIG. 13 is a circuit diagram showing a constitution example of an electrostatic detection circuit according to a thirteenth embodiment of the present invention;

FIG. 14 is a circuit diagram showing a constitution example of an electrostatic detection circuit according to a fourteenth embodiment of the present invention;

FIG. 15 is a circuit diagram showing a constitution example of an electrostatic protection circuit;

FIG. 16 is a sectional view of a semiconductor device of an n-type MOS transistor and a p-type MOS transistor; and

FIG. 17 is an equivalent circuit diagram in the case in which the electrostatic protection circuit in FIG. 15 performs a protection operation.

### DETAILED DESCRIPTION OF THE PREFERRED EMBODIMENTS

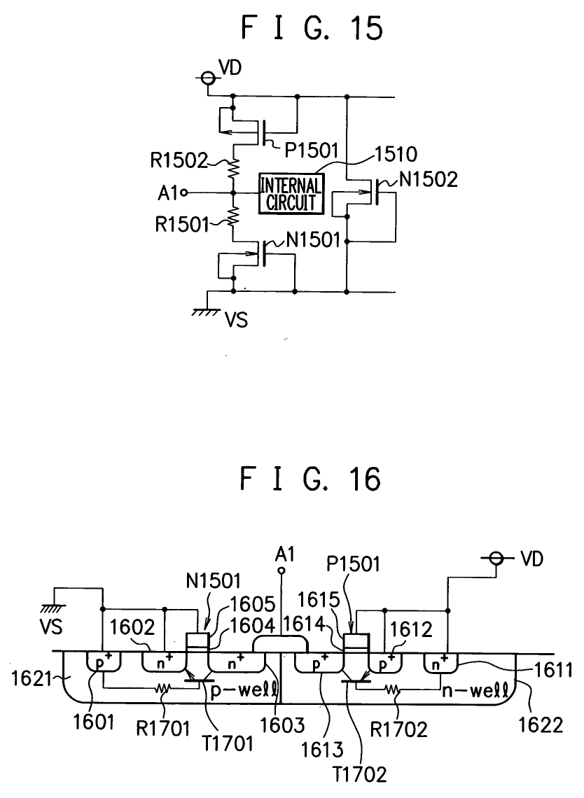

FIG. 15 is a circuit diagram showing a constitution example of an electrostatic (ESD) protection circuit. A semiconductor device has an external power supply terminal VD, an external ground terminal VS and an external signal terminal A1. The external signal terminal A1 is connected to an internal circuit 1510. The electrostatic protection circuit is provided to prevent breakdown of the internal circuit 1510 when static electricity is inputted from the external power supply terminal VD, the external ground terminal VS or the external signal terminal A1.

Next, a constitution of the electrostatic protection circuit will be explained. An n-type (n-channel) MOS (metal-oxide semiconductor) field-effective transistor N1501 has a gate and a source connected to the external ground terminal VS, and has a drain connected to the external signal terminal A1 via a resistor R1501. Hereinafter, the MOS field-effective transistor will be called the MOS transistor. A p-type (p-channel) MOS transistor P1501 has a gate and a source connected to the external power supply terminal VD, and has a drain connected to the external signal terminal A1 via a resistor R1502. An n-type MOS transistor N1502 has a gate and a source connected to the external ground terminal VS, and has a drain connected to the external power supply terminal VD.

When the semiconductor device including the electrostatic protection circuit is mounted on a board (circuit board), the external power supply terminal VD is connected to a power supply potential, the external ground terminal VS is connected to a ground potential, and the semiconductor device is normally operated. The p-type MOS transistor P1501 is off because the power supply potential is supplied to the gate. The n-type MOS transistors N1501 and N1502 are off because the ground potential is supplied to the gates. The internal circuit 1510 can input or output a signal from and to the external signal terminal A1.

FIG. 16 is a sectional view of the semiconductor device of the n-type MOS transistor N1501 and the p-type MOS transistor P1501 in FIG. 15. A p-type well 1621 and an n-type well 1622 are provided in the surface of the semiconductor substrate (for example, a silicon substrate).

A p⁺ type region 1601 and n⁺ type regions 1602 and 1603 are provided in the p-type well 1621. The n⁺ type region 1602 is a source, the n⁺ type region 1603 is a drain, and the p⁺ type region 1601 is a back gate. A gate 1605 is provided on a channel between the source 1602 and the drain 1603 via a gate insulation film 1604. These things constitute the n-type MOS transistor N1501. The gate 1605, the source 1602 and the back gate 1601 are connected to the external ground terminal VS. The drain 1603 is connected to the external signal terminal A1 via the resistor by the contact.

An n⁺ type region 1611 and p+ type regions 1612 and 1613 are provided in the n-type well 1622. The p⁺ type region 1612 is a source, the p⁺ type region 1613 is a drain, and an n⁺ type region 1611 is a back gate. A gate 1615 is provided on a channel between the source 1612 and the drain 1613 via a gate insulation film 1614. These things constitute the p-type MOS transistor P1501. The gate 1615, the source 1612 and the back gate 1611 are connected to the external power supply terminal VD. The drain 1613 is connected to the external signal terminal A1 via the resistor by the contact.

The semiconductor device has parasitic bipolar transistors T1701 and T1702. In the npn-type bipolar transistor T1701, a collector corresponds to the drain 1603, and an emitter corresponds to the source 1602. A base of the bipolar transistor T1701 is connected to the external ground terminal VS via a resistor R1701 in the p-type well 1621. In the pnp-type bipolar transistor T1702, a collector corresponds to the drain 1613 and an emitter corresponds to the source 1612. The base of the bipolar transistor T1702 is connected to the external power supply terminal VD via a resistor 1702 in the n-type well 1622.

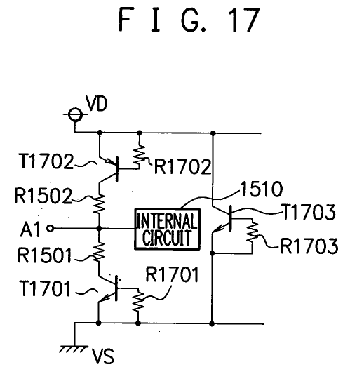

When static electricity is applied to the external terminal VD, VS or A1, the parasitic bipolar transistors T1701 and T1702 operate. Namely, at the time of application of the static electricity, the circuit in FIG. 15 is expressed by an equivalent circuit in FIG. 17.

FIG. 17 is an equivalent circuit diagram in which the electrostatic protection circuit in FIG. 15 performs a protection operation. In the npn-type bipolar transistor T1701, the base is connected to the external ground terminal VS via the resistor R1701, the emitter is connected to the external ground terminal VS, and the collector is connected to the external signal terminal A1 via the resistor R1501. In the pnp-type bipolar transistor T1702, the base is connected to the external power supply terminal VD via the resistor R1702, the emitter is connected to the external power supply terminal VD, and the collector is connected to the external signal terminal A1 via the resistor R1502. In an npn-type bipolar transistor T1703, a base is connected to an external ground terminal VS via a resistor R1703, an emitter is connected to the external ground terminal VS, and a collector is connected to the external power supply terminal VD. The internal circuit 1510 is connected to the external signal terminal A1.

Before the semiconductor device including the electrostatic protection circuit is mounted on the board, the external terminals VD, VS and A1 are in the open state, and it is a main object of the semiconductor device including the electrostatic protection circuit to protect the internal circuit 1510 from static electricity on this occasion. When positive static electricity at high voltage is applied to the external signal terminal A1 with the external ground terminal VS as the reference, breakdown of the pn junction of the drain and the back gate of the n-type MOS transistor N1501 in FIG. 15 occurs, and the npn-type bipolar transistor T1701 in FIG. 17 is turned on. The static electricity can be discharged to the external ground terminal VS from the external signal terminal A1, and the internal circuit 1510 can be protected.

When negative static electricity at high voltage is applied to the external signal terminal A1 with the external power supply terminal VD as the reference, breakdown of the pn junction of the drain and the back gate of the p-type MOS transistor P1501 in FIG. 15 occurs similarly, and the pnp-type bipolar transistor T1702 in FIG. 17 is turned on. The static electricity can be discharged to the external signal terminal A1 from the external power supply terminal VD, and the internal circuit 1510 can be protected.

When positive static electricity at high voltage is applied to the external power supply terminal VD with the external ground terminal VS as the reference, breakdown of the pn junction of the drain and the back gate of the n-type MOS transistor N1502 in FIG. 15 occurs similarly, and the npn type bipolar transistor T1703 in FIG. 17 is turned on. The static electricity can be discharged to the external reference terminal VS from the external power supply terminal VD, and the internal circuit 1510 can be protected.

In order to enhance the electrostatic protection function, a plurality of MOS transistors N1501 are connected in parallel, so that a large electric current can be passed. When the static electricity is applied, any one of a plurality of MOS transistors N1501 breaks down first. Thereafter, in order to break down the other MOS transistors N1501, the resistor R1501 is provided so that the external signal terminal A1 also keeps high voltage for a predetermined time period after the first breakdown. By the effect of the resistor R1501, a plurality of MOS transistors N1501 break down, and can be turned on as the npn-type bipolar transistors T1701. In order to break down a plurality of MOS transistors P1501 similarly, the resistor R1502 is required.

As described above, the MOS transistors N1501, P1501 and N1502 are brought into the non-conducting state in the circuit in FIG. 15, and at a point of the when the voltage exceeds the breakdown voltage of the pn junction, they are operated in the circuit shown in the equivalent circuit diagram in FIG. 17. Namely, the operation of the parasitic bipolar transistor, which operates with the source of the MOS transistor as the emitter, the back gate as the base, and the drain as the collector, is expected, and the internal circuit is protected by controlling the parasitic bipolar transistor by interposing the resistor in the drain.

Further, in FIG. 15, a clamp element N1502 is used between the external power supply terminal VD and the external ground terminal VS in order to reduce electrostatic charge concentration to the external signal terminal A1. For example, when positive electric charge is applied to the external signal terminal A1 with the external ground terminal VS as the reference, the potential of the external signal terminal A1 rises, and an electric current flows into the clamp element N1502 via the pn junction between the drain and the back gate of the p-type MOS transistor P1501 between the external signal terminal A1 and the external power supply terminal VD, in addition to that the n-type MOS transistor N1501 between the external signal terminal A1 and the external ground terminal VS operates as the parasitic bipolar transistor T1701. The clamp element N1502 operates as the parasitic bipolar transistor T1703, and thereby the current concentration to the n-type MOS transistor N1501 can be reduced.

However, when the voltage between the drain and the back gate of the n-type MOS transistor N1501, or between the back gate and the drain of the p-type MOS transistor P1501 exceeds the breakdown voltage of the pn junction, an electric current instantaneously flows between the source and the drain. At this time, the potential difference occurs between the source and the back gate due to the resistance of the well, and therefore, the parasitic lateral bipolar transistor operation with the potential difference as V_{BE} is caused.

The electrostatic protection element generally secures necessary transistor width by parallel connection of a plurality of small transistors. On this occasion, if part of a plurality of small transistors causes the parasitic bipolar transistor operation, the voltage between the drain and the back gate reduces to a fixed voltage. Therefore, only the transistors which start the parasitic bipolar transistor operation first among a plurality of small transistors are brought into the conducting state. As a result, the electric current concentrates to the conducting transistors, and therefore the transistors easily break down. In order to prevent the breakdown by the current concentration, the resistor is placed at the drain part of the electrostatic protection element.

Even if only the part of the small transistors are in conduction by placing the resistor in the drain part, the potential difference between the drains and the back gates of the other transistors which are not in conduction reaches the breakdown voltage before too much electrical current is passed into the part of the small transistors, whereby the other transistors are brought into the conducting state stepwise, and current concentration hardly occurs to the specific transistors.

However, when the start trigger of the protection operation is set as the breakdown of the pn junction, there is the fear that the MOS transistor in the internal circuit to be protected breaks down before the voltage of the pn junction of the MOS transistors placed as the protection elements reaches the breakdown voltage.

Further, in the case of the n-type MOS transistor, interposing the resistor in the drain part causes the problem that the area of the entire protection element is increased and the parasitic capacitance is also increased by the increase in the drain area.

Embodiments of the present invention to solve the above-described problems will be explained hereinafter.

### First Embodiment

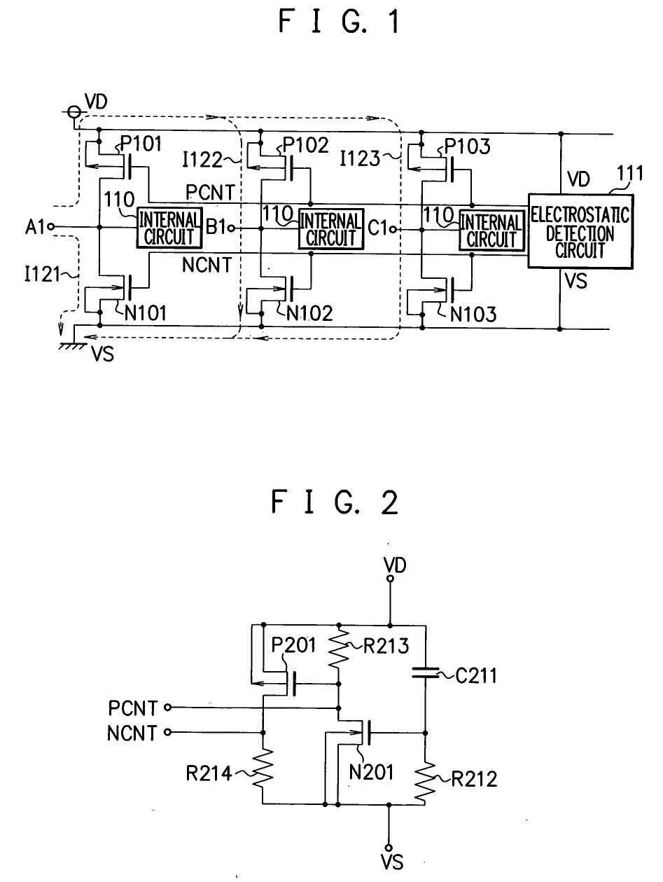

FIG. 1 is a circuit diagram showing a constitution example of an electrostatic protection circuit according to a first embodiment of the present invention. A semiconductor device has an external power supply terminal VD, an external ground terminal VS and external signal terminals (input/output terminals) A1, B1 and C1. The external signal terminals A1, B1 and C1 are connected to internal circuits 110. The electrostatic protection circuit is provided to prevent breakdown of the internal circuits 110 when static electricity is inputted from the external power supply terminal VD, the external ground terminal VS or the external signal terminals A1, B1 and C1.

Next, the constitution of the electrostatic protection circuit will be explained. An n-type MOS transistor N101 has a source connected to the external ground terminal VS and a drain connected to the external signal terminal A1. A p-type MOS transistor P101 has a source connected to the external power supply terminal VD and a drain connected to the external signal terminal A1. An n-type MOS transistor N102 has a source connected to the external ground terminal VS and a drain connected to the external signal terminal B1. A p-type MOS transistor P102 has a source connected to the external power supply terminal VD and a drain connected to the external signal terminal B1. An n-type MOS transistor N103 has a source connected to the external ground terminal VS and a drain connected to the external signal terminal C1. A p-type MOS transistor P103 has a source connected to the external power supply terminal VD and a drain connected to the external signal terminal C1.

An electrostatic detection circuit 111 is connected to the external power supply terminal VD and the external ground terminal VS. When the electrostatic detection circuit 111 does not detect static electricity, it turns off the p-type MOS transistors P101, P102 and P103 and the n-type MOS transistors N101, N102 and N103 via output lines PCNT and NCNT, and when it detects static electricity, it turns on the p-type MOS transistors P101, P102 and P103 and the n-type MOS transistors N101, N102 and N103 via the output lines PCNT and NCNT. The output line PCNT of the electrostatic detection circuit 111 is connected to gates of the p-type MOS transistors P101, P102 and P103. The output line NCNT of the electrostatic detection circuit 111 is connected to gates of the n-type MOS transistors N101, N102 and N103.

When the semiconductor device including the electrostatic protection circuit is mounted on a board, the external power supply terminal VD is connected to power supply potential, and the external ground terminal VS is connected to ground potential to perform a normal operation. The p-type MOS transistors P101, P102 and P103 are off because the power supply potential is supplied to the gates. The n-type MOS transistors N101, N102 and N103 are off because the ground potential is supplied to the gates. The internal circuits 110 can input or output signals to and from the external signal terminals A1, B1 and C1.

When electrostatic pulse of positive charge is applied to the external signal terminal A1 with the external ground terminal VS as the reference, the potential of the external signal terminal A1 rises with respect to the external ground terminal VS. With this, the potential of the external power supply terminal VD also rises via pn junction constructed between the drain and a back gate of the p-type MOS transistor P101. Forward voltage is applied to the pn junction.

When rapid potential difference occurs between the external power supply terminal VD and the external ground terminal VS by this, the electrostatic detection circuit 111 operates to output a low level (low potential) to the output line PCNT and output a high level (high potential) to the output line NCNT. The n-type MOS transistor N101 is on (conducting state), an electric current 1121 flows, and the electric charge of the external signal terminal A1 can be discharged to the external ground terminal VS.

The electrostatic detection circuit 111 is connected between the external power supply terminal VD and the external ground terminal VS, and controls the protection elements P101 to P103 and N101 to N103 of all the external signal terminals A1, B1 and C1. Therefore, not only the n-type MOS transistor N101 but also the protection elements of the external signal terminals B1 and C1, namely, the n-type MOS transistors N102 and N103 and the p-type MOS transistors P102 and P103 are on during the above-described operation, and electric currents 1122 and 1123 flow. Thus the electric charge can be also discharged between the external power supply terminal VD and the external ground terminal VS.

The above operation is the same when static electricity is applied to the external signal terminals B1 and C1. When static electricity is applied to the optional external signal terminal A1, B1 or C1, not only the protection MOS transistors P101 and N101 placed at the external signal terminal A1 to which the static electricity is applied, but also the protection MOS transistors P102, N102, P103, and N103 are on as to the external signal terminals B1 and C1 other than the external signal terminal A1 to which the static electricity is applied, and thereby, the current paths 1122 and 1123 are secured between the external power supply terminal VD and the external ground terminal VS to make it possible to protect the internal circuit 110 connected to the terminal A1 to which the static electricity is applied.

When electrostatic pulse of negative electric charge is applied to the external signal terminal A1 with the external power supply terminal VD as the reference, the electric potential of the external signal terminal A1 lowers with respect to the external power supply terminal VD. With this, the electric potential of the external ground terminal VS also lowers via the pn junction constructed between the drain and a back gate of the n-type MOS transistor N101. As a result, rapid electric potential difference occurs between the external power supply terminal VD and the external ground terminal VS as described above, and therefore the protection operation occurs. Namely, the electrostatic detection circuit 111 detects static electricity, and turns on the MOS transistors P101 to P103 and N101 to N103.

The case of electrostatic application other than the above-description will be explained. When the electrostatic pulse of negative electric charge is applied to the external signal terminal A1 with the external ground terminal VS as the reference, the n-typ MOS transistor N101 operates as the pn junction diode, whereby electric current flows into the external signal terminal A1 from the external ground terminal VS, and the internal circuit 110 can be protected.

When electrostatic pulse of positive electric charge is applied to the external signal terminal A1 with the external power supply terminal VD as the reference, the p-type MOS transistor P101 operates as the pn junction diode, whereby the electric current flows into the external power supply terminal VD from the external signal terminal A1, and the internal circuit 110 can be protected.

According to this embodiment, when the static electricity is applied to the external terminals of the semiconductor device, the MOS transistors N101 to N103 and p101 to P103, which are placed for the purpose of electrostatic protection, are turned on, whereby the current paths 1121, 1122 and 1123 to the external ground terminal VS or the external power supply terminal VD can be secured, and the internal circuit 110 can be protected.

### Second Embodiment

FIG. 2 is a circuit diagram showing a constitution example of the electrostatic detection circuit 111 in FIG. 1 according to a second embodiment of the present invention. A p-type MOS transistor P201 has a source connected to the external power supply terminal VD, has a drain connected to the external ground terminal VS via a resistor R214, and has a gate connected to a drain of an n-type MOS transistor N201. The n-type MOS transistor N201 has a source connected to the external ground terminal VS, and has the drain connected to the external power supply terminal VD via a resistor R213. A capacitor C211 and a resistor R212 are connected in series between the external power supply terminal VD and the external ground terminal VS. The resistor R212 is connected between the gate of the n-type MOS transistor N201 and the external ground terminal VS. The output line PCNT is connected to the drain of the n-type MOS transistor N201. The output line NCNT is connected to the drain of the p-type MOS transistor P201.

At the time of a normal operation, the power supply potential is supplied to the external power supply terminal VD, and the ground potential is supplied to the external ground terminal VS. As a result, the MOS transistors P201 and N201 are turned off, the output line PCNT becomes high-level (power supply potential), and the output line NCNT becomes low-level (ground potential). Accordingly, the MOS transistors N101 to N103 and P101 to P103 in FIG. 1 are turned off (non-conducting state).

On the other hand, when static electricity is applied to the external signal terminal A1, rapid potential difference change occurs between the external power supply terminal VD and the external ground terminal VS as explained in the first embodiment. Due to delay by the RC time constant of the resistor R212 and the capacitor C211, the gate potential of the n-type MOS transistor N201 does not immediately follow the potential change between the external power supply terminal VD and the external ground terminal VS, and therefore, it is temporarily in the high potential state. Therefore, the n-type MOS transistor N201 and the p-type MOS transistor P201 are temporarily on, and while the gate potential of the n-type MOS transistor N201 is high, the output line PCNT becomes low-level, the output line NCNT becomes high-level, and the MOS transistors N101 to N103 and P101 to P103 in FIG. 1 are turned on. As a result, the MOS transistors N101 to N103 and P101 to P103 can be operated as the protection elements.

According to this embodiment, on application of static electricity from the outside, the MOS transistors N101 to N103 and P101 to P103, which are placed for the purpose of electrostatic protection, are on only for a fixed time due to the RC time constant from the application, whereby the current path to the external ground terminal VS or the external power supply terminal VD is secured, and the internal circuit 110 can be protected.

### Third Embodiment

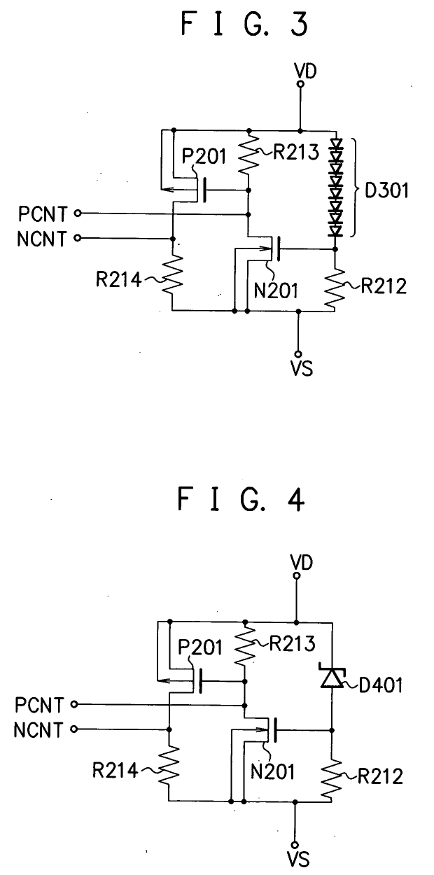

FIG. 3 is a circuit diagram showing a constitution example of the electrostatic detection circuit 111 in FIG. 1 according to a third embodiment of the present invention. A circuit in FIG. 3 differs from the circuit in FIG. 2 only in the respect that a diode group D301 is provided in place of the capacitor C211. In the diode group D301, a plurality of diodes are connected in series, an anode is connected to the external power supply terminal VD, and a cathode is connected to a gate of the n-type MOS transistor N201. The diode group D301 and the resistor R212 are connected in series between the external power supply terminal VD and the external ground terminal VS.

The number of diodes in series is such a number as includes at least the number of diodes which are not brought into the conducting state with respect to the power supply voltage at the time of normal use, and as is brought into the conducting state before the pn junction between the drains and the back gates of the protection elements N101 to N103 and P101 to P103 break down by electrostatic application. For example, when the forward on-voltage of this diode is 0.5 V, the power supply voltage is 2.7 V, and the breakdown voltage is 12 V, the number of diodes in series is from 6 to 23 inclusive.

When the normal operation is performed with this condition satisfied, the series diode group D301 is not brought into the conducting state at the power supply voltage, and therefore, the gate potential of the n-type MOS transistor N201 keeps ground potential. However, when the potential difference between the external power supply terminal VD and the external ground terminal VS exceeds the value of design, the series diode group D301 is brought into the conducting state. Therefore, the gate potential of the n-type MOS transistor N201 becomes high-level only while the electric potential difference between the external power supply terminal VD and the external ground terminal VS exceeds the value of design, and the MOS transistors N201 and P201 are turned on. The output line PCNT becomes low-level, the output line NCNT becomes high-level, the protection elements N101 to N103 and P101 to P103 are turned on, and can perform the protection operation.

According to this embodiment, on application of static electricity from the outside, the MOS transistors N101 to N103 and P101 to P103, which are placed for the purpose of the electrostatic protection, are in the conducting state when the potential difference between the external power supply terminal VD and the external ground terminal VS exceeds a fixed value by to the forward on-voltage of the diode group D301, whereby the current path to the external power supply terminal VD or the external ground terminal VS is secured, and the internal circuit 110 can be protected.

### Fourth Embodiment

FIG. 4 is a circuit diagram showing a constitution example of the electrostatic detection circuit 111 in FIG. 1 according to a fourth embodiment of the present invention. A circuit in FIG. 4 differs from the circuit in FIG. 3 only in the respect that a Zener diode D401 is provided in place of the diode group D301. The Zener diode D401 has a cathode connected to the external power supply terminal VD, and an anode connected to a gate of the n-type MOS transistor N201. The Zener diode D401 and the resistor R212 are connected in series between the external power supply terminal VD and the external ground terminal VS.

The Zener diode D401 is brought into a conducting state at a point of time when the voltage exceeds reverse bias withstand voltage previously designed, and the MOS transistors N210 and P201 are turned on. The output line PCNT becomes low-level, the output line NCNT becomes high-level, and the protection elements N101 to N103 and P101 to P103 are turned on and can perform the protection operation.

According to this embodiment, on application of static electricity from the outside, the MOS transistors N101 to N103 and P101 to P103, which are placed for the purpose of electrostatic protection, are brought into the conducting state when the potential difference between the external power supply terminal VD and the external ground terminal VS exceeds a fixed value by the reverse bias withstand voltage of the Zener diode D401, whereby the current path to the external power supply terminal VD or the external ground terminal VS is secured, and the internal circuit 110 can be protected.

### Fifth Embodiment

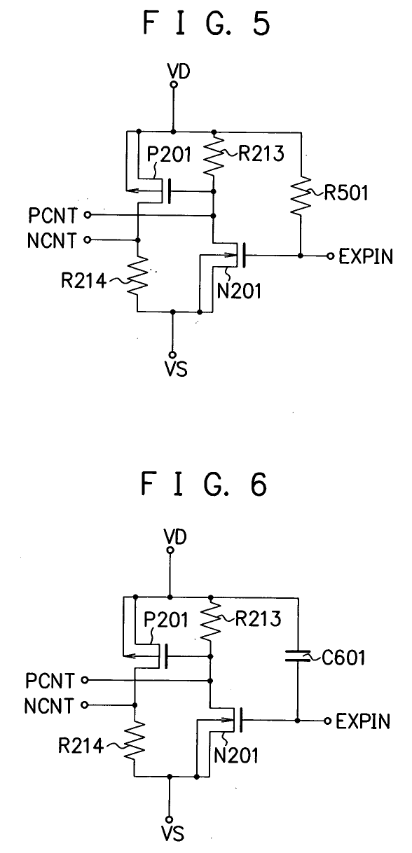

FIG. 5 is a circuit diagram showing a constitution example of the electrostatic detection circuit 111 in FIG. 1 according to a fifth embodiment of the present invention. A circuit in FIG. 5 differs from the circuit in FIG. 2 in the respect that a resistor R501 is provided in place of the capacitor C211 and the resistor R212. An external control terminal EXPIN is connected to the gate of the n-type MOS transistor N201. The resistor R501 is connected between the external power supply terminal VD and the external control terminal EXPIN. The external control terminal EXPIN is in the open state before the semiconductor device is mounted on the board, and after the semiconductor device is mounted on the board, the external control terminal EXPIN is connected to the ground potential with the external ground terminal VS.

Since the external control terminal EXPIN is connected to the ground potential at the time of normal use, the MOS transistor N201 or P201 is turned off. As a result, the output line PCNT becomes high-level, the output line NCNT becomes low-level, and the n-type MOS transistors N101 to N103 and P-type MOS transistors P101 to P103, which are protection elements, are turned off.

On the other hand, when static electricity is applied to the optional external terminal in the state in which the power is not inputted, the external control terminal EXPIN is in the open state with respect to the outside, and as a result, the external control terminal EXPIN is in the state in which it short-circuits to the external power supply terminal VD. Therefore, the MOS transistors N201 and P201 are turned on. The output line PCNT becomes low-level, the output line NCNT becomes high-level, and the protection elements N101 to N103 and P101 to P103 are turned on. The applied electric charge is discharged to the external power supply terminal VD or the external ground terminal VS.

According to this embodiment, the external control terminal EXPIN is provided separately from the external terminals VD, VS, A1, B1 and C1, which are used for the normal operation, and when the static electricity is applied before the semiconductor device is mounted on the board, the MOS transistors N101 to N103 and P101 to P103 are turned on for the purpose of electrostatic protection, whereby the current path to the external power supply terminal VD or the external ground terminal VS is secured, and the internal circuit 110 can be protected from the static electricity.

### Sixth Embodiment

FIG. 6 is a circuit diagram showing a constitution example of the static electricity detection circuit 111 according to a sixth embodiment of the present invention. A circuit in FIG. 6 differs from the circuit in FIG. 5 in the respect that a capacitor C601 is provided in place of the resistor R501. The capacitor C601 is connected between the external power supply terminal VD and the external control terminal EXPIN.

Before the semiconductor device is mounted on the board, the external control terminal EXPIN and the external power supply terminal VD are short-circuited only when pulse charge such as static electricity is applied, and the external control terminal EXPIN becomes high-level. Then, the MOS transistors N201 and P201 are turned on, the output line PCNT becomes low-level, and the output line NCNT becomes high-level. The protection elements N101 to N103 and P101 to P103 are turned on, and the applied electric charge is discharged to the external power supply terminal VD or the external ground terminal VS.

At the time of normal operation after the semiconductor device is mounted on the board, direct-current power supply potential is supplied to the external power supply terminal VD, and therefore, the external power supply terminal VD and the external control terminal EXPIN are insulated. The external control terminal EXPIN is connected to the ground potential as described above, and therefore, the MOS transistors N201 and P201 are turned off. As a result, the protection elements N101 to N103 and P101 to P103 are also turned off.

### Seventh Embodiment

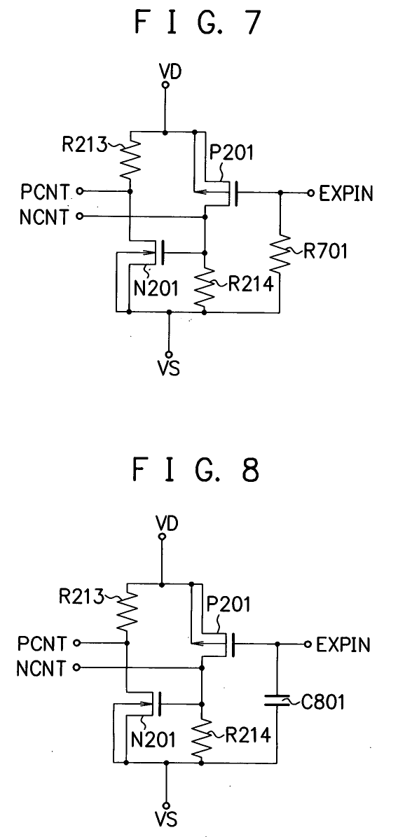

FIG. 7 is a circuit diagram showing a constitution example of the electrostatic detection circuit 111 in FIG. 1 according to a seventh embodiment of the present invention. A circuit in FIG. 7 differs from the circuit in FIG. 5 in the respect that a resistor R701 is provided in place of the resistor R501 and the external control terminal EXPIN is connected to the gate of the p-type MOS transistor P201. The resistor R701 is connected between the external ground terminal VS and the external control terminal EXPIN. The external control terminal EXPIN is clipped to the external ground terminal VS via the resistor R701. The external control terminal EXPIN is in the open state before the semiconductor device is mounted on the board, and after the semiconductor device is mounted on the board, the external control terminal EXPIN is connected to the power supply potential with the external power supply terminal VD.

At the time of normal use after the semiconductor device is mounted on the board, the external control terminal EXPIN is fixed at power supply potential, and thereby, the MOS transistors P201 and N201 are turned off. The output line PCNT becomes high-level, the output line NCNT becomes low-level, and the protection elements N101 to N103 and P101 to P103 are turned off.

On the other hand, in the state in which the power supply is not inputted before the semiconductor substrate is mounted on the board, the external control terminal EXPIN is in then open state to the outside. When static electricity is applied to the arbitrary external terminal, the external control terminal EXPIN becomes low-level, and the MOS transistors P201 and N201 are turned on. The output line PCNT becomes low-level, the output line NCNT becomes high-level, and the protection elements N101 to N103 and P101 to P103 are turned on. The applied electric charge is discharged to the external power supply terminal VD or the external ground terminal VS.

### Eighth Embodiment

FIG. 8 is a circuit diagram showing a constitution example of the electrostatic detection circuit 111 in FIG. 1 according to an eighth embodiment of the present invention. The circuit in FIG. 8 differs from the circuit in FIG. 7 in the respect that a capacitor C801 is provided in place of the resistor R701. The capacitor C801 is connected between the external ground terminal VS and the external control terminal EXPIN.

Before the semiconductor device is mounted on the board, the external control terminal EXPIN and the external ground terminal VS short-circuit only when the pulse electric charge such as static electricity is applied, and the external control terminal EXPIN becomes low-level. The MOS transistors N201 and P201 are turned on, the output line PCNT becomes low-level, and the output line NCNT becomes high-level. The protection elements N101 to N103 and P101 to P103 are turned on, and the applied electric charge is discharged to the external power supply terminal VD or the external ground terminal VS.

At the time of the normal operation after the semiconductor device is mounted on the board, a direct-current ground potential is supplied to the external ground terminal VS, and therefore, the external ground terminal VS and the external control terminal EXPIN are insulated. The external control terminal EXPIN is connected to the power supply potential as described above, and therefore, the MOS transistors N201 and P201 are turned off. As a result, the protection elements N101 to N103 and P101 to P103 are also turned off.

### Ninth Embodiment

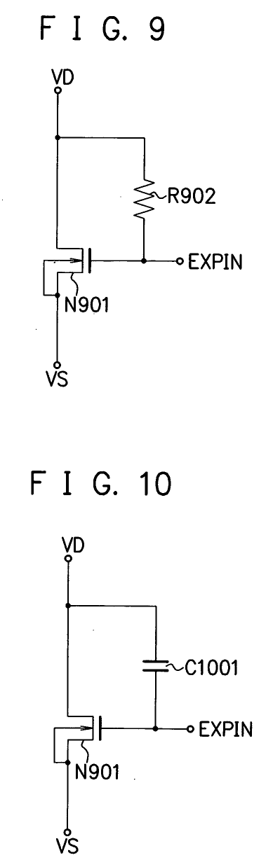

FIG. 9 is a circuit diagram showing a constitution example of an electrostatic protection circuit according to a ninth embodiment of the present invention. This electrostatic protection circuit corresponds to the MOS transistor N1502 in FIG. 15, and is connected in parallel with the electrostatic protection circuit in FIG. 1.

An n-type MOS transistor N901 has a gate connected to the external control terminal EXPIN, a source connected to the external ground terminal VS, and a drain connected to the external power supply terminal VD. A resistor R902 is connected between the external power supply terminal VD and the external control terminal EXPIN. The external control terminal EXPIN is in the open state before the semiconductor device is mounted on the board, and after the semiconductor device is mounted on the board, the external control terminal EXPIN is connected to the ground potential with the external ground terminal VS.

After the semiconductor device is mounted on the board, the external control terminal EXPIN has the contact potential. Therefore, the MOS transistor N901 is turned off, and the external power supply terminal VD and the external ground terminal VS are insulated.

Before the semiconductor device is mounted on the board, the external control terminal EXPIN is in the open state to the outside. When the positive electrostatic pulse is applied to the external power supply terminal VD with the external reference terminal VS as the reference, the external control terminal EXPIN becomes high-level, and the MOS transistor N901 is turned on. The electric charge of the external power supply terminal VS is discharged to the external ground terminal VS. On this occasion, the protection elements N101 to N103 and P101 to P103 in FIG. 1 are also turned on, but in the circuit in FIG. 1, the external power supply terminal VD and the external ground terminal VS are connected with the two MOS transistors (p-type MOS transistor and n-type MOS transistor) therebetween. On the other hand, in the circuit in FIG. 9, the external power supply terminal VD and the external ground terminal VS are connected with the one MOS transistor N901 therebetween. Therefore, the on-resistance is small, and an electric current preferentially flows into the electrostatic protection circuit in FIG. 9.

When positive electrostatic pulse is applied to the external ground terminal VS with the external power supply terminal VD as the reference, electric charge is discharged to the external power supply terminal VD from the external ground terminal VS via the pn junction between a back gate and the drain of the MOS transistor N901. Forward voltage is applied to the pn junction.

In this embodiment, as the application of the circuits in the fifth to eigth embodiments, the target of the control is changed from the protection elements N1010 to N1-3 and P101 to P103 to the protection element N901. The protection element N901 in this case corresponds to the protection element N1502 in FIG. 15.

According to this embodiment, the MOS transistor N901 for electrostatic protection connected between the external power supply terminal VD and the external ground terminal VS is controlled by the external control terminal EXPIN. If the external control terminal EXPIN is in the open state to the outside, the MOS transistor N901 is turned on when static electricity is applied to the external terminal. As a result, the conducting state is established between the external power supply terminal VD and the external ground terminal VS, and therefore, the internal circuit 110 can be protected against the application of the static electricity.

### Tenth Embodiment

FIG. 10 is a circuit diagram showing a constitution example of an electrostatic protection circuit according to a tenth embodiment of the present invention. The circuit in FIG. 10 differs from the circuit in FIG. 9 only in the respect that a capacitor C1001 is provided in place of the resistor R902. The capacitor C1001 is connected between the external power supply terminal VD and the external control terminal EXPIN.

Before the semiconductor device is mounted on the board, the external control terminal EXPIN and the external power supply terminal VD short-circuit and the external control terminal EXPIN becomes high-level only when positive electrostatic pulse is applied to the external power supply terminal VD with the external ground terminal VS as the reference. The MOS transistor N901 is turned on and the electric charge of the external power supply terminal VD is discharged to the external ground terminal VS.

At the time of normal operation after the semiconductor device is mounted on the board, direct-current power supply potential is supplied to the external power supply terminal VD, and therefore, the external power supply terminal VD and the external control terminal EXPIN are insulated. Since the external control terminal EXPIN is connected to the ground potential as described above, the MOS transistor N201 is turned off. As a result, the external power supply terminal VD and the external ground terminal VS are insulated.

### Eleventh Embodiment

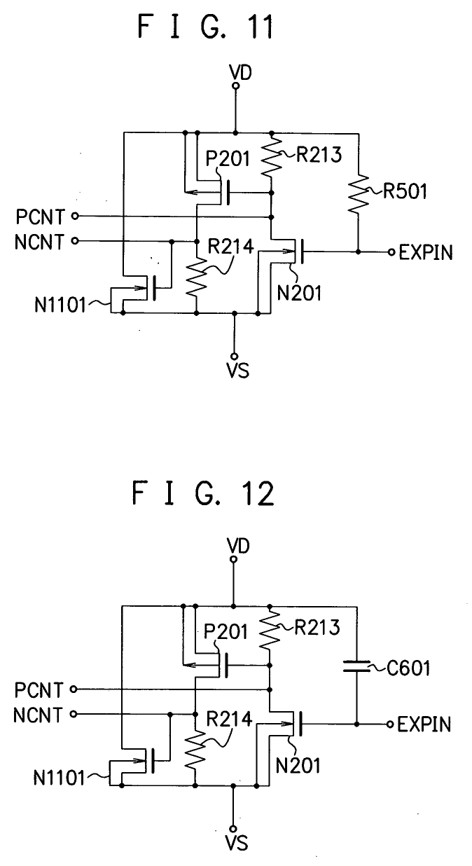

FIG. 11 is a circuit diagram showing a constitution example of the electrostatic detection circuit 111 in FIG. 1 according to an eleventh embodiment of the present invention. This embodiment is the embodiment in which the fifth embodiment (FIG. 5) and the ninth embodiment (FIG. 9) are combined. A circuit in FIG. 11 differs from the circuit in FIG. 5 in the respect that an n-type MOS transistor N1101 is added. The n-type MOS transistor N1101 has a gate connected to the drain of the p-type MOS transistor P201, a source connected to the external ground terminal VS, and a drain connected to the external power supply terminal VD. The n-type MOS transistor N1101 is controlled according to the level of the output line NCNT, and functions as a protection element similarly to the n-type MOS transistor N901 in the ninth embodiment (FIG. 9).

When electrostatic pulse is applied to the external terminal, the external control terminal EXPIN becomes high-level, and the MOS transistors N201 and P201 are turned on as in the fifth embodiment. Then, the output line NCNT becomes high-level, and the MOS transistor N1101 is turned on. As a result, when the static electricity is detected, the protection element N1101 is also turned on with the protection elements N101 to N103 and P101 to P103, and therefore, the circuit of this embodiment has higher electrostatic protection ability as compared with the circuits in the fifth to eighth embodiments.

### Twelfth Embodiment

FIG. 12 is a circuit diagram showing a constitution example of the electrostatic detection circuit 111 according to a twelfth embodiment of the present invention. This embodiment is the embodiment in which the sixth embodiment (FIG. 6) and the ninth embodiment (FIG. 9) are combined. The circuit in FIG. 12 differs from the circuit in FIG. 6 in the respect that the n-type MOS transistor N1101 is added. The n-type MOS transistor N1101 has a gate connected to the drain of the p-type MOS transistor P201, the source connected to the external ground terminal VS and the drain connected to the external power supply terminal VD. The n-type MOS transistor N1101 is controlled according to the level of the output line NCNT and functions as the protection element as in the eleventh embodiment.

### Thirteenth Embodiment

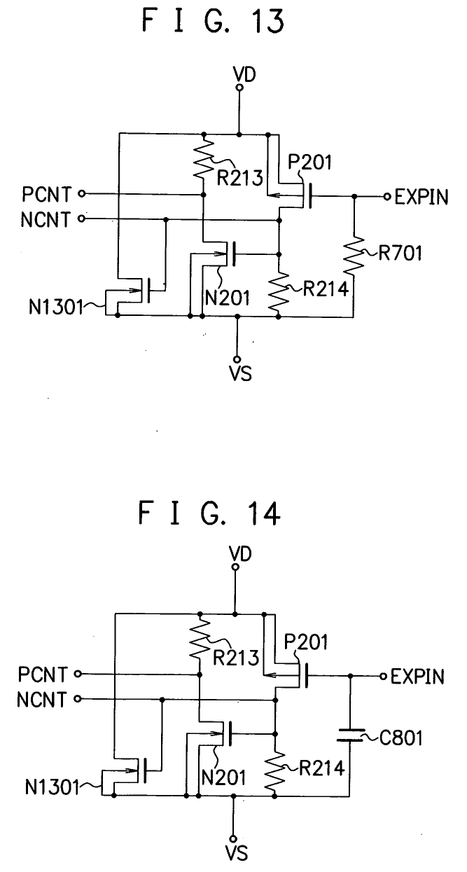

FIG. 13 is a circuit diagram showing a constitution example of the electrostatic detection circuit 111 in FIG. 1 according to a thirteenth embodiment of the present invention. This embodiment is the embodiment in which the seventh embodiment (FIG. 7) and the ninth embodiment (FIG. 9) are combined. A circuit in FIG. 13 differs from the circuit in FIG. 7 in the respect that the n-type MOS transistor N1301 is added. The n-type MOS transistor N1301 has a gate connected to the drain of the p-type MOS transistor P201, a source connected to the external ground terminal, and a drain connected to the external power supply terminal VD. The n-type MOS transistor N1301 is controlled according to the level of the output line NCNT and functions as the protection element, similarly to the n-type MOS transistor N1101 in the eleventh embodiment.

### Fourteenth Embodiment

FIG. 14 is a circuit diagram showing a constitution example of the electrostatic detection circuit 111 in FIG. 1 according to a fourteenth embodiment of the present invention. This embodiment is the embodiment in which the eighth embodiment (FIG. 8) and the ninth embodiment (FIG. 9) are combined. A circuit in FIG. 14 differs from the circuit in FIG. 8 in the respect that the n-type MOS transistor N1301 is added. The n-type MOS transistor N1301 has the gate connected to the drain of the p-type MOS transistor P201, the source connected to the external ground terminal VS, and the drain connected to the external power supply terminal VD. This n-type MOS transistor N1301 is controlled according to the level of the output line NCNT and functions as the protection element, similarly to the n-type MOS transistor N1101 in the eleventh embodiment.

As described above, in each of the electrostatic protection circuits of the first to the eighth and the eleventh to the fourteenth embodiments, the p-type MOS transistors P101 to P103 and the n-type MOS transistors N101 to N103 which are in the conducting state at the time of protection operation are connected to the external signal terminals A1, B1 and C1, and the electrostatic protection circuit 111 controls these MOS transistors N101 to N103 and P101 to P103.

Though the breakdown voltage of the pn junction of the protection elements pl501, N1501 and N1502 themselves is made the trigger of the protection operation in the electrostatic protection circuit in FIG. 15, the protection elements N101 to N103 and P101 to P103 are not operated as the bipolar transistors, but operated as the MOS transistors by the electrostatic detection circuit 111 which detects rapid voltage change, and thereby the breakdown of the internal circuit 110 can be prevented in this embodiment.

The electrostatic detection circuit 111 is connected between the external power supply VD and the external ground terminal VS, detects static electricity, and controls the protection elements N101 to N103 and p110 to p103. Thus, the protection elements N101 to N103 and P101 to P103 of all the external signal terminals A1, B1 and C1 are brought into the conducting state by electrostatic application to the arbitrary external signal terminal A1, B1 or C1, and the internal circuit 110 can be protected.

The electrostatic protection circuit in FIG. 15 utilizes the operation at the breakdown voltage of the pn junction, and therefore, the protection operation is not started unless certain degree of high voltage is applied to the protection elements P1501 and N1501. This is also true of the protection element N1502 having the same circuit structure. Therefore, when the static electricity is applied to the external signal terminal A1, there is a fear that the internal circuit 1510 is broken before the protection operation is started.

As the MOS transistors P1501, N1501 and N1502, which are generally used as the protection elements, a plurality of transistors of the same sizes are connected in parallel. Here, in order to prevent electric current concentration to the specific MOS transistor by the protection operation by the parasitic bipolar transistor operation, it is necessary to interpose the resistors R1501 and R1502 in the drain parts, and therefore, there is the problem that the element area and parasitic capacitance on the external signal terminal A1 become large.

In this embodiment, when the potential difference between the external power supply terminal VD and the external contact terminal VS rapidly rises due to application of static electricity, the electrostatic detection circuit 111 controls the protection elements N101 to N103 and P101 to P103 so that these protection elements are in the conducting state, and the electric charge is discharged to the external ground terminal VS or the external power supply terminal VD. The electrostatic detection circuit 111 turns on the protection element transistors N101 to N103 and P101 to P103 at low voltage (transistor threshold voltage) before exceeding the breakdown voltage of the pn junction of the protection element transistors N101 to N103 and P101 to P103, and therefore, the electrostatic protection circuit reliably operates at high speed. As a result, the internal circuit 110 can be more reliably protected.

In the electrostatic protection circuit in FIG. 15, the potential difference between the external power supply terminal VD and the external ground terminal VS rapidly rises in all the cases when the protection operation by the aforementioned parasitic bipolar transistor operation occurs, and therefore, protection is performed by the parasitic bipolar transistor operation. On the other hand, in this embodiment, protection is performed by the MOS transistor operation.

In this embodiment, the protection elements N101 to N103 and P101 to P103 are brought into the conducting state by application of static electricity, and therefore, it is not necessary to provide the resistors R1501 and R1502 at the drain part to prevent electric current concentration as in the circuit in FIG. 15. As a result, it is possible to reduce the circuit area of the input/output parts of the semiconductor device and parasitic capacitance, and it is possible to contribute to high integration and speeding up of the internal circuit 110.

When the potential difference between the external power supply terminal and the external ground terminal rapidly rises by application of static electricity, the electrostatic detection circuit performs control so that the first p-type field-effect transistor and the first n-type field effect transistor are turned on. As a result, the electric charge is discharged to the external power supply terminal or the external ground terminal. The electrostatic detection circuit turns on the first p-type and n-type field-effect transistors at low voltage (transistor threshold voltage) before exceeding the breakdown voltage of the pn junction of the first p-type or n-type field-effect transistor, and therefore, the electrostatic protection circuit operates reliably at high speed. Since the first p-type and n-type field-effect transistors are turned on by application of static electricity, it is not necessary to connect a resistor to prevent current concentration to the drains of them. As a result, it is possible to reduce the circuit area and parasitic capacitance, and it is possible to contribute to high integration and speeding up of the internal circuit.

The present embodiments are to be considered in all respects as illustrative and no restrictive, and all changes which come within the meaning and range of equivalency of the claims are therefore intended to be embraced therein. The invention may be embodied in other specific forms without departing from the spirit or essential characteristics thereof.

What is claimed is:

1. An electrostatic protection circuit, comprising:
an external power supply terminal;
an external ground terminal;
a first external signal terminal;
a first p-type field-effect transistor having a source and a drain respectively connected to said external power supply terminal and said first external signal terminal;
a first n-type field-effect transistor having a source and a drain respectively connected to said external ground terminal and said first external signal terminal; and
an electrostatic detection circuit connected to said external power supply terminal and said external ground terminal, and turning off said first p-type field-effect transistor and said first n-type field-effect transistor when the electrostatic detection circuit does not detect static electricity and turning on said first p-type field-effect transistor and said first n-type field-effect transistor when the electrostatic detection circuit detects static electricity.

2. The electrostatic protection circuit according to claim 1, further comprising:
a second external signal terminal;
a second p-type field-effect transistor having a source and a drain respectively connected to said external power supply terminal and said second external signal terminal; and
a second n-type field-effect transistor having a source and a drain respectively connected to said external ground terminal and said second external signal terminal,
wherein said electrostatic detection circuit turns off said first and second p-type field-effect transistors and said first and second n-type field-effect transistor when said electrostatic detection circuit does not detects static electricity, and turns on said first and second p-type field-effect transistors and said first and second n-type field-effect transistors when said electrostatic detection circuit detects static electricity.

3. The electrostatic protection circuit according to claim 1,
wherein said electrostatic detection circuit further comprises
a second p-type field-effect transistor having a source connected to said external power supply terminal, and a drain connected said external ground terminal via a first resistor, and
a second n-type field-effect transistor having a source connected to said external ground terminal, and a drain connected to said external power supply terminal via a second resistor,
wherein a gate of said first p-type field-effect transistor is connected to the drain of the second n-type field-effect transistor; and
wherein a gate of said first n-type field-effect transistor is connected to the drain of the second p-type field-effect transistor.

4. The electrostatic protection circuit according to claim 3, wherein a gate of the second p-type field-effect transistor is connected to the drain of the second n-type field-effect transistor.

5. The electrostatic protection circuit according to claim 4, wherein said electrostatic detection circuit further comprises a third resistor connected between a gate of the second n-type field-effect transistor and said external ground terminal.

6. The electrostatic protection circuit according to claim 5, wherein said electrostatic detection circuit further comprises a first capacitor connected between said external power supply terminal and the gate of the second n-type field-effect transistor.

7. The electrostatic protection circuit according to claim 5, wherein said electrostatic detection circuit further comprises one diode or a plurality of diodes connected between said external power supply terminal and the gate of the second n-type field-effect transistor.

8. The electrostatic protection circuit according to claim 7, wherein the diode is a Zener diode.

9. The electrostatic protection circuit according to claim 4, wherein said electrostatic detection circuit further comprises an external control terminal connected to the gate of the second n-type field-effect transistor.

10. The electrostatic protection circuit according to claim 9, wherein said electrostatic detection circuit further comprises a third resistor connected between said external power supply terminal and said external control terminal.

11. The electrostatic protection circuit according to claim 9, wherein said electrostatic detection circuit further comprises a first capacitor connected between said external power supply terminal and said external control terminal.

12. The electrostatic protection circuit according to claim 3, wherein a gate of the second n-type field-effect transistor is connected to the drain of the second p-type field-effect transistor.

13. The electrostatic protection circuit according to claim 12, wherein said electrostatic detection circuit further comprises an external control terminal connected to a gate of the second p-type field-effect transistor.

14. The electrostatic protection circuit according to claim 13, wherein said electrostatic detection circuit further comprises a third resistor connected between the external control terminal and said external ground terminal.

15. The electrostatic protection circuit according to claim 13, wherein said electrostatic detection circuit further comprises a first capacitor connected between the external control terminal and said external ground terminal.

16. The electrostatic protection circuit according to claim 1, further comprising:
a second n-type field-effect transistor having a source and a drain respectively connected to said external ground terminal and said external power supply terminal;
an external control terminal connected to a gate of said second n-type field-effect transistor; and
a first resistor connected between said external control terminal and said external power supply terminal.

17. The electrostatic protection circuit according to claim 1, further comprising:
a second n-type field-effect transistor having a source and a drain respectively connected to said external ground terminal and said external power supply terminal;
an external control terminal connected to a gate of said second n-type field-effect transistor; and
a first capacitor connected between said external control terminal and said external power supply terminal.

18. The electrostatic protection circuit according to claim 10, further comprising:
a third n-type field-effect transistor having a source and a drain respectively connected to said external ground terminal and said external power supply terminal, and having a gate connected to the drain of the second p-type field-effect transistor.

19. The electrostatic protection circuit according to claim 11, further comprising:
a third n-type field-effect transistor having a source and a drain respectively connected to said external ground terminal and said external power supply terminal, and having a gate connected to the drain of the second p-type field-effect transistor.

20. The electrostatic protection circuit according to claim 14, further comprising:
a third n-type field-effect transistor having a source and a drain respectively connected to said external ground terminal and said external power supply terminal, and having a gate connected to the drain of the second p-type field-effect transistor.

21. The electrostatic protection circuit according to claim 15, further comprising:
a third n-type field-effect transistor having a source and a drain respectively connected to said external ground terminal and said external power supply terminal, and having a gate connected to the drain of the second p-type field-effect transistor.

22. An electrostatic protection circuit, comprising:
an n-type field-effect transistor having a source and a drain respectively connected to said external ground terminal and said external power supply terminal;
an external control terminal connected to a gate of said n-type field-effect transistor; and
a resistor connected between said external control terminal and said external power supply terminal.

23. An electrostatic protection circuit, comprising:
an n-type field-effect transistor having a source and a drain respectively connected to said external ground terminal and said external power supply terminal;
an external control terminal connected to a gate of said n-type field-effect transistor; and
a capacitor connected between said external control terminal and said external power supply terminal.
